(19) United States
(12) Patent Application Publication
(10) Pub. No.: US 2024/0334452 A1
(43) Pub. Date: Oct. 3, 2024

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/579,102

(22) PCT Filed: Jul. 16, 2021
(86) PCT No.: PCT/CN2021/106930

§ 371 Date: Jan. 12, 2024

(51) Int. Cl. H04W 72/232; H04L 5/00; H04W 24/08

(52) U.S. Cl. CPC H04W 72/232; H04L 5/0053; H04L 5/0094; H04W 24/08

(57) ABSTRACT

Embodiments of the present disclosure relate to methods, devices and computer readable media for communication. A terminal device receives an indication of at least one transmission configuration indicator (TCI) state in a detected downlink control information (DCI) in a first physical downlink control channel (PDCCH). The terminal device also receives a downlink transmission from the network device based on the at least one TCI state based on a first condition. The terminal device further applies the at least one TCI state to at least one reference signal (RS) in a first RS set based on the first condition, wherein the first RS set is applied for beam failure detection. Moreover, the terminal device determines an estimation of a radio link quality between the terminal device and the network device based on the first RS set. In this way, proper beam failure detection can be processed.

### TECHNICAL FIELD

Embodiments of the present disclosure generally relate to the field of telecommunication, and in particular, to methods, devices and computer storage media for communication.

### BACKGROUND

In the third generation partnership project (3GPP) meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management. For example, it is proposed to support common beam(s) for data and control information transmission/reception for both DL and UL. It is also proposed to support a unified Transmission Configuration Indication (TCI) framework for DL and UL beam indication. Moreover, multi-input multi-output (MIMO) has been proposed, which includes features that facilitate utilization of a large number of antenna elements at a base station for both sub-6 GHz and over 6-GHz frequency bands. Therefore, it is worth enhancing multi-beam operations.

### SUMMARY

In general, embodiments of the present disclosure provide methods, devices and computer storage media for communications.

In a first aspect, there is provided a method of communication. The method comprises: receiving, at a terminal device and from a network device, an indication of at least one transmission configuration indicator (TCI) state in a detected downlink control information (DCI) in a first physical downlink control channel (PDCCH); receiving a downlink transmission from the network device based on the at least one TCI state based on a first condition; applying the at least one TCI state to at least one reference signal (RS) in a first RS set based on the first condition or including a third RS which is indicated by the at least one TCI state into the first RS set based on the first condition, wherein the first RS set is applied for beam failure detection; and determining an estimation of a radio link quality between the terminal device and the network device based on the first RS set.

In a second aspect, there is provided a method of communication. The method comprises: determining, at a terminal device, an estimation of a radio link quality according to a first reference signal (RS) and a second RS; transmitting, to a network device, a request for an indication of a transmission configuration indicator (TCI) state in an uplink resource based on a first situation; and monitoring one or more physical downlink control channels (PDCCHs) in one or more control resource sets (CORESETs).

In a third aspect, there is provided a method of communication. The method comprises: transmitting, at a network device and to a terminal device, an indication of at least one transmission configuration indicator (TCI) state in downlink control information (DCI) in a first physical downlink control channel (PDCCH); transmitting, to the terminal device, a downlink transmission from the network device based on the at least one TCI state based on a first condition; and transmitting at least one reference signal (RS) in a first RS set based on the first condition, wherein the first RS set is applied for beam failure detection.

In a fourth aspect, there is provided a method of communication. The method comprises: transmitting, at a network device and to a terminal device, a first reference signal (RS) and a second RS; transmitting, to the terminal device, a first set of physical downlink control channels (PDCCHs) in one or more control resource sets (CORESETs) with a third state; receiving, from the terminal device, a request for an indication of transmission configuration indicator (TCI) state in an uplink resource; and transmitting, to the terminal device, a second set of PDCCHs in the one or more CORESETs with a fourth TCI state based on the reception of the request.

In a fifth aspect, there is provided a terminal device. The terminal device comprises a processor and a memory coupled to the processor. The memory stores instructions that when executed by the processor, cause the terminal device to perform the method according to the first aspect of the present disclosure.

In a sixth aspect, there is provided a terminal device. The terminal device comprises a processor and a memory coupled to the processor. The memory stores instructions that when executed by the processor, cause the terminal device to perform the method according to the second aspect of the present disclosure.

In a seventh aspect, there is provided a network device. The network device comprises a processor and a memory coupled to the processor. The memory stores instructions that when executed by the processor, cause the network to perform the method according to the third aspect of the present disclosure.

In an eighth aspect, there is provided a network device. The network device comprises a processor and a memory coupled to the processor. The memory stores instructions that when executed by the processor, cause the network device to perform the method according to the fourth aspect of the present disclosure.

In a ninth aspect, there is provided a computer readable medium having instructions stored thereon. The instructions, when executed on at least one processor, cause the at least one processor to perform the method according to the first, second, third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a signaling flow for communication according to some example embodiments of the present disclosure;

FIG. 3 illustrates an example for configuration of beam application at the terminal device in accordance with some embodiments of the present disclosure;

FIG. 4 illustrates an example for configuration of beam application at the terminal device in accordance with some embodiments of the present disclosure;

FIG. 5 illustrates an example for configuration of beam application at the terminal device in accordance with some embodiments of the present disclosure;

FIG. 6 illustrates an example for configuration of beam application at the terminal device in accordance with some embodiments of the present disclosure;

FIG. 7 illustrates an example for configuration of beam application at the terminal device in accordance with some embodiments of the present disclosure;

FIG. 8 illustrates a signaling flow for communication according to some example embodiments of the present disclosure;

FIG. 9 illustrates an example for configuration of beam application at the terminal device in accordance with some embodiments of the present disclosure;

FIG. 10 illustrates an example for beam failure detection in accordance with some embodiments of the present disclosure;

FIG. 11 illustrates a flow chart of an example method of communication implemented at a terminal device in accordance with some embodiments of the present disclosure;

FIG. 12 illustrates a flow chart of an example method of communication implemented at a terminal device in accordance with some embodiments of the present disclosure;

FIG. 13 illustrates a flow chart of an example method of communication implemented at a network device in accordance with some embodiments of the present disclosure;

FIG. 14 illustrates a flow chart of an example method of communication implemented at a network device in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, for uplink (UL) transmission, one TRP usually corresponds to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions).

As mentioned above, there are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NAK of the PDSCH scheduled by the DCI carrying the beam indication can be used as an ACK also for the DCI.

It is also proposed to support activation of one or more TCI states via medium access control (MAC) control element (CE) analogous to Release.15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the TDRA field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Formatl-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1’s; MCS=all ‘1’s; NDI=0; and set to all ‘0’s for FDRA Type 0, or all ‘1’s for FDRA Type 1, or all ‘0’s for dynamicSwitch (same as in Table 10.2-4 of TS38.213).

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats; carrier indicator; bandwidth part indicator; time domain resource assignment (TDRA); downlink assignment index (if configured); transmit power control (TPC) command for scheduled PUCCH; PUCCH resource indicator; PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot or the first subslot that is at least X ms or Y symbols after the last symbol of the acknowledgment of the joint or separate DL/UL beam indication.

In some embodiments, a slot comprises 14 or 12 Orthogonal Frequency Divided Multiplexing (OFDM) symbols. In some embodiments, a subslot comprises at least one of {2, 4, 7} OFDM symbols.

According to TS 38.212 section 7.3.1.2.2 Format 1_1, Transmission configuration indication—0 bit if higher layer parameter tci-PresentInDCI is not enabled; otherwise 3 bits as defined in Clause 5.1.5 of [6, TS38.214]. According to TS 38.212 section 7.3.1.2.3 Format 1_2, Transmission configuration indication—0 bit if higher layer parameter tci-PresentDCI-1-2 is not configured; otherwise 1 or 2 or 3 bits determined by higher layer parameter tci-PresentDCI-1-2 as defined in Clause 5.1.5 of [6, TS38.214].

The UE receives an activation command, as described in clause 6.1.3.14 of [10, TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2. For example, if the number of bits for the DCI field ‘Transmission Configuration Indication’ of DCI format 1_2 or the number of bits of higher layer parameter tci-PresentDCI-1-2 is 1 bit, then S=2. For another example, if the number of bits for the DCI field ‘Transmission Configuration Indication’ of DCI format 1_2 or the number of bits of higher layer parameter tci-PresentDCI-1-2 is 2 bits, then S=4. For another example, if the number of bits for the DCI field ‘Transmission Configuration Indication’ of DCI format 1_2 or the number of bits of higher layer parameter tci-PresentDCI-1-2 is 3 bits, then S=8.

Moreover, DCI format 1_1/1_2 with and without DL assignment can be used for dynamic beam indication. If beam indication is indicated by DCI format with DL scheduling, ACK/NACK of PDSCH can be used to indicate ACK of the beam indication, and after a timing, indicated beam can be applied.

However, if there is mismatch between beam(s)/TCI state(s) for beam failure detection (BFD) reference signal (RS) and indicated common beam(s)/TCI state(s), beam failure detection on BFD RS is not suitable to monitor the link quality. Moreover, if there is mismatch between beam(s)/TCI state(s) for BFD RS and indicated common beam(s)/TCI state(s), beam failure detection on BFD RS is not suitable to monitor the link quality. If the indicated beam/TCI state is failed/blocked, UE cannot obtain indication of other beam(s)/TCI state(s), unless beam failure recovery (BFR). After BFR, the new identified beam will be used for PDCCH (CORESET), which can be regarded as the new common beam. But how to handle the TCI field in the PDCCH (CORESET) need to be defined. There is TCI field in the PDCCH, which will indicate TCI state(s), while the activated TCI state(s) which can be indicated may not be suitable any more (e.g. already failed), which may lead to unnecessary/unsuitable beam update.

In order to solve at least part of the above problems, solutions on beam indication are proposed. A terminal device receives an indication of at least one transmission configuration indicator (TCI) state in a detected downlink control information (DCI) in a first physical downlink control channel (PDCCH). The terminal device also receives a downlink transmission from the network device based on the at least one TCI state based on a first condition. The terminal device further applies the at least one TCI state to at least one reference signal (RS) in a first RS set based on the first condition, wherein the first RS set is applied for beam failure detection. Moreover, the terminal device determines an estimation of a radio link quality between the terminal device and the network device based on the first RS set. In this way, proper beam failure detection can be processed.

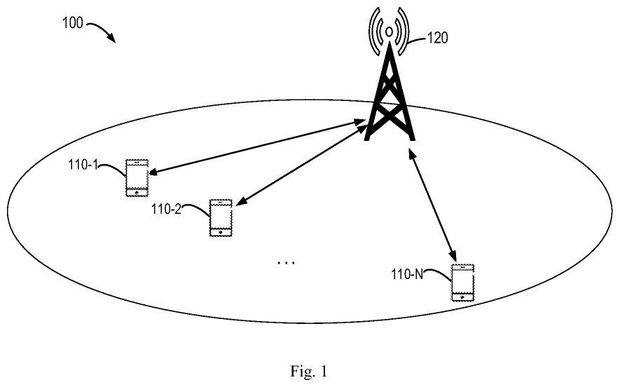

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. Only for the purpose of illustrations, embodiments of the present disclosure are described with the reference to the terminal device 110-1.

The communication system 100 further comprises a network device 120. In the communication system 100, the network device 120 and the terminal devices 110 can communicate data and control information to each other. The numbers of devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In some embodiments, the TRPs may be explicitly associated with different higher-layer configured identities. For example, a higher-layer configured identity can be associated with a Control Resource Set (CORESET), a group of CORESETs, a reference signal (RS), a set of RS, a Transmission Configuration Indication (TCI) state or a group of TCI states, which is used to differentiate between transmissions between different TRPs and the terminal device 110-1. When the terminal device 110-1 receives two DCIs from two CORESETs which are associated with different higher-layer configured identities, the two DCIs are indicated from different TRPs. Further, the TRPs may be implicitly identified by a dedicated configuration to the physical channels or signals. For example, a dedicated CORESET, a RS, and a TCI state, which are associated with a TRP, are used to identify a transmission from a different TRP to the terminal device 110. For example, when the terminal device 110-1 receives a DCI from a dedicated CORESET, the DCI is indicated from the associated TRP dedicated by the CORESET. In some embodiments, the RS may be at least one of CSI-RS, SRS, positioning RS, uplink DMRS, downlink DMRS, uplink PTRS and downlink PTRS.

In the repeated transmission or reception via the two TRPs, the network device 120 may select a repetition scheme from among a number of available repetition schemes. The repetition scheme may specify a transmission manner for the network device 120 to use the two TRPs cooperatively, for example, a multiplexing scheme between the two TRPs, the respective resource allocations for the two TRPs, or the like.

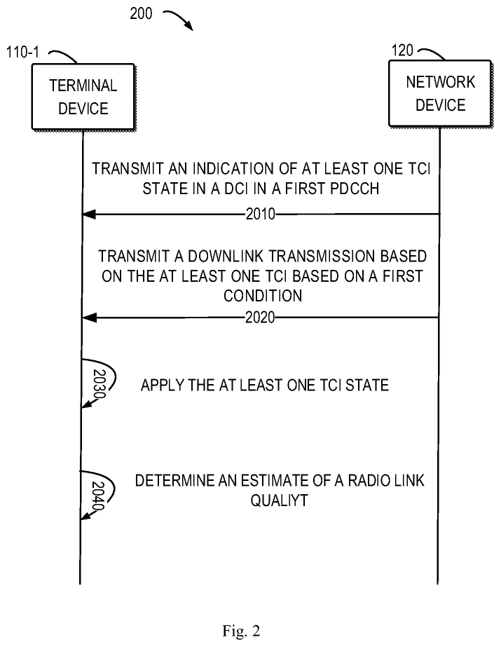

FIG. 2 illustrates a signaling chart for communication between network device and terminal device in accordance with some embodiments of the present disclosure. For the purpose of discussion, the process 200 will be described with reference to FIG. 1. The process 200 may involve the network device 120 and the terminal device 110-1 as shown in FIG. 1.

The network device 120 transmits 2010 an indication of at least one TCI state in DCI in a first PDCCH to the terminal device 110-1. In addition, before transmitting data to the terminal device 110, the network device 120 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV). It is to be understood that the transmission parameters indicated in the control information are not limited to the ones as listed above. Embodiments of the present disclosure may equally applicable to control information including any transmission parameters.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot or the first subslot that is after slot n+3Nₛₗₒₜ^{subframe,μ} where μ is the SCS configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 10), the UE assumes that the TCI field is not present in the DCI (for example DCI format 1_1 or DCI format 1_2 or DCI format 10) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DMRS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 12) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot or the subslot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets,
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enableDefaultBeam-ForCCS:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μ_{PDCCH}<μ_{PDSCH} an additional timing delay d is added to the timeDurationForQCL, where d is defined as 8 symbols if subcarrier spacing for the PDCCH is 15 kHz, or 8 symbols if subcarrier spacing for the PDCCH is 30 kHz, or 14 symbols if subcarrier spacing for the PDCCH is 60 kHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DMRS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DMRS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably. The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0,1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rys is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-
AggregationFactor is present

| | |
|---|---|
| rv_{id} indicated | rv_{id} to be applied to |
| by the DCI | n^{th} transmission occasion |

| scheduling | n mod | n mod | n mod | n mod |
|---|---|---|---|---|
| the PDSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second TCI state when RVSeqOffset is present

| rv_{id} indicated by the DCI | rv_{id} to be applied to nth transmission occasion with second TCI state | | | |
|---|---|---|---|---|
| scheduling the PDSCH | n mod 4 = 0 | n mod 4 = 1 | n mod 4 = 2 | n mod 4 = 3 |
| 0 | (0 + rvₛ) mod 4 | (2 + rvₛ) mod 4 | (3 + rvₛ) mod 4 | (1 + rvₛ) mod 4 |
| 2 | (2 + rvₛ) mod 4 | (3 + rvₛ) mod 4 | (1 + rvₛ) mod 4 | (0 + rvₛ) mod 4 |
| 3 | (3 + rvₛ) mod 4 | (1 + rvₛ) mod 4 | (0 + rvₛ) mod 4 | (2 + rvₛ) mod 4 |
| 1 | (1 + rvₛ) mod 4 | (0 + rvₛ) mod 4 | (2 + rvₛ) mod 4 | (3 + rvₛ) mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P_{BWP,i}′ is determined as “wideband”, the first

$$⌈ \frac{{n}_{PRB}}{2} ⌉$$

PRBs are assigned to the first TCI state and the remaining

$$⌊ \frac{{n}_{PRB}}{2} ⌋$$

PRBs are assigned to the second TCI state, where n_{PRB} is the total number of allocated PRBs for the UE. If P_{BWP,i}′ is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0,1 are applied to the first and second TCI state, respectively.

In some embodiments, there is an application timing for beam indication or TCI state(s) indication. In some embodiments, the application timing may be the first slot or first subslot that is at least X ms or Y symbols after the last symbol of the acknowledge of the joint or separate DL/UL beam indication. For example, Y may be integer, and 1<=Y<=336. In some embodiments, slot may include 12 or 14 symbols. In some embodiments, subslot may include S symbols. S is integer, and 1<=S<=14. For example, S may be at least one of {2, 4, 7}. In some embodiments, the beam indication is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI. For example, when the DCI schedules the PDSCH. In some embodiments, the acknowledge of the joint or separate DL/UL beam indication may be the acknowledge of the DCI. For example, when the DCI doesn't schedule a PDSCH.

In some embodiments, the terminal device may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, the second time threshold H2 may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the second time threshold H2. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the second time threshold H2. For another example, when a DL TCI state is indicated in the DCI, the DL TCI state may be applied to PDSCH and/or CORESET and/or downlink RS after the application timing or the second time threshold H2. For another example, when an UL TCI state is indicated in the DCI, the UL TCI state may be applied to PUSCH and/or PUCCH and/or uplink RS after the application timing or the second time threshold H2. For another example, when a pair of DL/UL TCI states are indicated in the DCI, the DL TCI state may be applied to PDSCH and/or CORESET and/or downlink RS after the application timing or the second time threshold H2, and the UL TCI state may be applied to PUSCH and/or PUCCH and/or uplink RS after the application timing or the second time threshold H2.

In some embodiments, the terminal device 110 may receive an indication to indicate a downlink TCI state (or a beam or a set of QCL parameters), and the source reference signal(s) in the TCI state provides QCL information at least for reception on PDSCH and all of CORESETs in a component carrier (CC). For example, the PDSCH is dedicated or UE-specific.

In some embodiments, the terminal device 110 may receive an indication to indicate an uplink TCI state (or a beam or a spatial relation), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 110 may receive an indication to indicate a joint TCI state (or a beam or a set of QCL parameters), and the TCI state refers to at least a common source reference signal used for determining both the downlink QCL information and the uplink transmission spatial filter.

In some embodiments, the terminal device 110 may receive an indication to indicate a downlink TCI state (or a beam or a set of QCL parameters) and an uplink TCI state (or a beam or a spatial relation), and the source reference signal(s) in the DL TCI state provides QCL information at least for reception on PDSCH and all of CORESETs in a component carrier (CC), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific. For another example, the PDSCH is dedicated or UE-specific.

In some embodiments, the terminal device 110 may be configured with more than one (For example, represented as M, M is positive integer. For example, M may be 2 or 3 or 4) downlink TCI states, and/or the terminal device 110 may receive an indication to indicate one of the M TCI states, and the source reference signal(s) in the one of the M TCI states or in the indicated one TCI state provides QCL information at least for reception on PDSCH and/or a subset of CORESETs in a CC. For example, the PDSCH is dedicated or UE-specific.

In some embodiments, the terminal device 110 may be configured with more than one (For example, represented as N, N is positive integer. For example, N may be 2 or 3 or 4) uplink TCI states, and/or the terminal device 110 may receive an indication to indicate one of the N TCI states, and the source reference signal(s) in the one of the N TCI states or in the indicated one TCI state provides a reference for determining uplink transmission spatial filter at least for dynamic grant or configured grant based PUSCH, and/or a subset of PUCCH resources in a CC. For example, the PUCCH is dedicated or UE-specific.

In some embodiments, the terminal device 110 may be configured with more than one (For example, represented as M, M is positive integer. For example, M may be 2 or 3 or 4) joint DL/UL TCI states, and/or receive an indication to indicate one from the M joint TCI states, and each one of the M TCI states or the indicated one TCI state refers to at least a common source reference signal used for determining both the downlink QCL information and the uplink transmission spatial filter.

In some embodiments, the terminal device 110 may be configured with more than one (For example, represented as M, M is positive integer. For example, M may be 2 or 3 or 4) downlink TCI states and the terminal device 110 may be configured with more than one (For example, represented as N, N is positive integer. For example, N may be 2 or 3 or 4) uplink TCI states, and/or the terminal device 110 may receive an indication to indicate one from the M downlink TCI states and one from the N uplink TCI states, and the source reference signal(s) in each one of the M DL TCI states or the indicated one DL TCI state provides QCL information at least for reception on PDSCH and/or a subset of CORESETs in a component carrier (CC), and the source reference signal(s) in each one of the N TCI states or in the indicated one UL TCI state provides a reference for determining uplink transmission spatial filter at least for dynamic grant or configured grant based PUSCH, and/or a subset of PUCCH resources in a CC. For example, the PUCCH is dedicated or UE-specific. For another example, the PDSCH is dedicated or UE-specific.

In the following, DCI_t may be used to describe the DCI for joint DL/UL TCI state indication or for separate DL/UL TCI state indication. In the following, the terms “DCI”, “PDCCH”, “DCI_t”, “DCI for joint DL/UL TCI state indication”, “DCI for separate DL/UL TCI state indication”, “DCI for DL TCI state indication”, “DCI for UL TCI state indication”, “PDCCH for joint DL/UL TCI state indication”, “PDCCH for separate DL/UL TCI state indication”, “PDCCH for DL TCI state indication”, “PDCCH for UL TCI state indication”, “DCI for TCI state indication” and “PDCCH for TCI state indication” can be used interchangeably.

In some embodiments, a DCI may be used for indicating a TCI state for joint DL/UL TCI state indication or for separate DL/UL TCI state indication. And the DCI may schedule a PDSCH (for example, DCI format 1_1 and format 1_2). In some embodiments, the HARQ of the PDSCH scheduled by the DCI can be used as an ACK for the DCI. For example, the DCI may be DCI_t.

In some embodiments, a DCI may be used for indicating a TCI state for joint DL/UL TCI state indication or for separate DL/UL TCI state indication. And the DCI may not schedule a PDSCH (for example, DCI format 1_1 and format 1_2). In some embodiments, a HARQ of the DCI may be introduced to indicate whether the DCI or the TCI state indication is successful. For example, the DCI may be DCI_t.

In some embodiments, if decoding of DCI_t or decoding of the PDSCH scheduled by DCI_t is ACK, the indicated TCI state may be applied for PDSCH and/or all or subset of CORESETs after an application timing.

In some embodiments, a DCI (for example, DCI_t) may be used for indicating one or more TCI states. For example, the one or more TCI states are for joint DL/UL TCI state indication or for separate DL/UL TCI state indication. And the DCI may not schedule a PDSCH (for example, DCI format 1_1 and format 1_2). In some embodiments, upon a successful reception/decoding of the DCI, the terminal device 110-1 may report an ACK. In some embodiments, upon a failed reception/decoding of the DCI, the terminal device 110-1 may report a NACK. For example, the ACK and/or NACK may be reported in a physical uplink control channel (PUCCH) or a physical uplink shared channel (PUSCH). In some embodiments, the terminal device 110-1 may be configured with a type of HARQ codebook. For example, the type may be at least one of Type 1 (for example, semi-static), Type 2 (for example, dynamic) and Type 3 (one shot feedback). For example, the type may be configured via at least one of RRC, MAC CE and DCI. In some embodiments, the DCI is received/detected in a PDCCH.

In some embodiments, the terminal device 110-1 may be configured/indicated with a first TCI state for reception of PDSCH and/or all or a subset of CORESETs. And the terminal device 110-1 may receive or detect a first PDCCH with the first TCI state, and the PDCCH is in a first CORESET. The terminal device 110-1 may be indicated with a second TCI state in the DCI received or detected in the first PDCCH. In some embodiments, the DCI in the first PDCCH may schedule or may not schedule a first PDSCH or a first PUSCH. In some embodiments, the terminal device 110-1 may report the decoding result or HARQ-ACK information for at least one of the DCI or the first PDCCH or the first PDSCH to the network device 120. For example, the decoding result or the HARQ-ACK information may be transmitted/reported in a PUCCH or in a second PUSCH. In some embodiments, after the application timing or after the second time threshold H2, the terminal device 110-1 may receive PDSCH and/or all or the subset of CORESETs with the second TCI state. For example, the terminal device 110-1 may receive a second PDCCH with the second TCI state, and the second PDCCH is in a second CORESET. For another example, the terminal device 110-1 may receive a second PDCCH with the second TCI state, and the second PDCCH is in the first CORESET.

The network device 120 transmits 2020 a downlink transmission based on the at last one TCI in accordance with a first condition to the terminal device 110-1. For example, the network device 120 may transmit downlink data to the terminal device 110-1. The network device 120 may transmit the downlink transmission on a beam which is corresponding to the at least one TCI. The first condition can be after or starting from a first timing. The first timing can be a beam application timing. Alternatively or in addition, the first condition can comprise a hybrid automatic repeat request acknowledgement (HARQ-ACK) corresponding to the detected DCI or a physical downlink shared channel (PDSCH) scheduled by the DCI is ACK. In some embodiments, the first PDCCH may start or end no earlier than a second PDCCH in a set of PDCCHs. In other words, the first PDCCH may start or end on later than any other PDCCH in the set of PDCCHs. In some embodiments, the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device 120 in a same resource.

The terminal device 110-1 applies 2030 the at least one TCI state to at least one reference signal (RS) in a first RS set based on the first condition. The first RS set is applied for beam failure detection. For example, the terminal device 110-1 can receive the first RS set on the beam which is corresponding to the at least one TCI. The first RS set can comprise any suitable number of reference signals.

In some embodiments, the at least one TCI state can be applied to a first RS in the first RS set based on the first condition. Alternatively or in addition, a second TCI state can be applied to a second RS in the first RS set; wherein the first RS set comprises the first RS and the second RS. In this case, the first RS can be an RS with lower or higher value of index in the first RS set. The second TCI state may be a default or fallback TCI state or a TCI state corresponding to a lowest codepoint from a set of codepoints activated via MAC CE. In some embodiments, the second TCI state can be the first TCI state.

In an example embodiment, the first RS set can be configured from the network device 120 with a higher layer parameter. Alternatively, the terminal device 110-1 can determine the first RS set based on a TCI state for one or more control resource sets (CORESETs).

The terminal device 110-1 determines 2040 an estimation of a radio link quality between the terminal device 110-1 and the network device 120 based on the first RS set. For example, the terminal device 110-1 can measure the first set of RSs. In this case, the terminal device 110-1 can estimate the radio link quality based on the measurement results of the first set of RS.

In some embodiments, the terminal device 110-1 may stop a first procedure based on a second condition and resume a second procedure based on the first condition. In some embodiments, the second condition can be after or starting from a second timing. For example, the second timing is no later or earlier than the first timing. In some embodiments, the second timing can be a timing when the DCI is detected in the first PDCCH. Alternatively or in addition, the second timing can be a timing when the PDSCH scheduled by the detected DCI is successfully decoded. Alternatively or in addition, the second timing can be a timing when the HARQ-ACK corresponding to the DCI or corresponding to the PDSCH scheduled by the detected DCI is generated at the terminal device.

In other embodiments, the second condition can comprise that the at least one TCI state is different from the a first TCI state. The first TCI state is applied to a PDCCH for the detected DCI and/or applied to the at least one RS in the first RS set. Alternatively or in addition, the second condition can comprise a hybrid automatic repeat request acknowledgement (HARQ-ACK) corresponding to the detected DCI or a PDSCH scheduled by the DCI is ACK. In some embodiments, the first PDCCH can start or end no earlier than a second PDCCH in a set of PDCCHs. The HARQ-ACK corresponding to the detected DCI in the first PDCCH or a PDSCH scheduled by the detected DCI in the first PDCCH and the HARQ-ACK corresponding to a detected DCI in the any other PDCCH may be reported to the network device in a same resource. In some embodiments, a value of beam failure indication counter can be set to 0 based on the second condition. In other embodiments, the terminal device 110-1 can ignore a TCI field in a detected DCI in a PDCCH after a third timing and/or until a fourth timing. In this case, the third timing can be when a beam failure recovery is successfully completed. The fourth timing can be when one or more TCI states are activated (or until the UE receives by higher layers an activation for a TCI state or any of the parameters tci-StatesPDCCH-ToAddList and/or tci-StatesPDCCH-ToReleaseList).

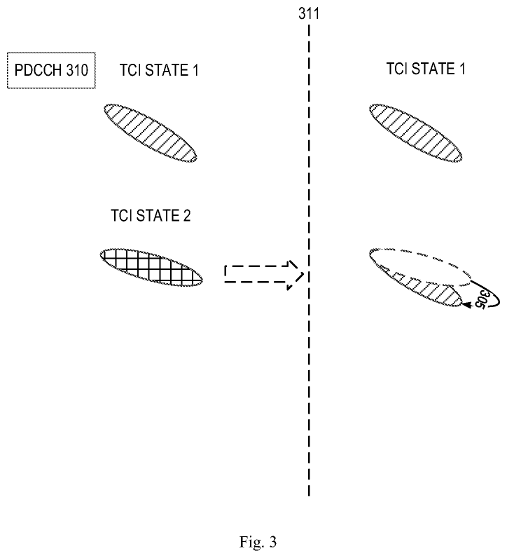

FIGS. 3-7 illustrate examples for configuration of beam application at the terminal device 110. FIGS. 3-7 are described with the reference to FIG. 1.

In some embodiments, the terminal device may receive at least one configuration of a first RS set for beam failure detection. In some embodiments, the first RS set may include at least one of: a first RS and a second RS. In some embodiments, the first RS set may include at least one of: an index of the first RS and an index of the second RS. For example, the terminal device may receive the at least one configuration via at least one of RRC and MAC CE.

In some embodiments, the terminal device may determine the first RS set to include at least one of an index of a first RS and an index of a second RS with same values as the RS indexes in the RS sets indicated by a TCI state for a CORESET, wherein the CORESET is used for monitoring PDCCH. For example, when the first RS set is not configured to the terminal device. In some embodiments, the first RS and/or the second RS is configured with qcl-Type set to ‘typeD’ for the TCI state.

In some embodiments, the first RS and/or the second RS is configured with a single port. In some embodiments, the first RS and/or the second RS is a CSI-RS.

In some embodiments, the terminal device may receive or detect or monitor a first PDCCH with a TCI (for example, represented as TCI_1), wherein TCI_1 may be any one of: a first joint TCI state, a first downlink TCI state, or a first downlink TCI state in a first pair of downlink TCI state and an uplink TCI state. In some embodiments, the first PDCCH may be in a first CORESET, and the CORESET is configured or indicated with the TCI_1.

In some embodiments, the terminal device may receive an indication of a TCI (for example, represented as TCI_2) in a detected DCI in the first PDCCH, wherein TCI_2 may be any one of: a second joint TCI state, a second downlink TCI state, or a second pair of downlink TCI state and an uplink TCI state. In some embodiments, the terminal device may receive a downlink transmission with the TCI_2 (for example, the second joint TCI state or the second downlink TCI state or the second downlink TCI state in the second pair of downlink TCI state and uplink TCI state) based on a first condition, wherein the downlink transmission may be at least one of PDSCH and all or a subset of CORESETs. In some embodiments, the terminal device may apply the TCI_2 (for example, the second joint TCI state or the second downlink TCI state or the second downlink TCI state in the second pair of downlink TCI state and uplink TCI state) to at least one RS in a first RS set based on the first condition. In some embodiments, the terminal device may include a third RS or an index of the third RS in the first RS set based on the first condition. In some embodiments, the terminal device may replace the first RS or the index of the first RS in the first RS set with the third RS or the index of the third RS based on the first condition. In some embodiments, the index of the third RS is configured with a same value as the RS index in the RS set indicated by TCI_2. In some embodiments, the third RS is configured with qcl-Type set to ‘typeD’ for TCI_2. In some embodiments, the third RS is configured with a single port. In some embodiments, the third RS is a CSI-RS. In some embodiments, the RS set indicated by TCI_2 may include one or two RS. In some embodiments, if none of the one or two RS in the RS set indicated by TCI_2 is configured with qcl-Type set to ‘typeD’ or none of the one or two RS in the RS set indicated by TCI_2 is a CSI-RS or the RS in the RS set configured with qcl-Type set to ‘typeD’ is not a CSI-RS or the RS in the RS set configured with qcl-Type set to ‘typeD’ is not configured with a single port, the terminal device may include a fourth RS or an index of the fourth RS in the first RS set based on the first condition. In some embodiments, the terminal device may replace the first RS or the index of the first RS in the first RS set with the fourth RS or the index of the fourth RS based on the first condition. In some embodiments, the fourth RS is an RS which is quasi co-located with the one or two RS in the RS set indicated by TCI_2 with ‘typeD’. In some embodiments, the fourth RS is an RS which is quasi co-located with ‘typeD’ with the RS in the RS set configured with qcl-Type set to ‘typeD’. In some embodiments, the fourth RS is a CSI-RS. In some embodiments, the fourth RS is configured with a single port.

In some embodiments, the first RS set may be used for beam failure detection. In some embodiments, the terminal device may assess a radio link quality (for example, a reference signal received power (RSRP)) based on the first RS set.

In some embodiments, the first RS set includes the first RS and the second RS. In some embodiments, the first RS set includes the index of the first RS and the index of the second RS. In some embodiments, the index of the first RS is lower than the index of the second RS. In some embodiments, the index of the first RS is larger than the index of the second RS.

In some embodiments, the terminal device may apply the TCI_2 (for example, the second joint TCI state or the second downlink TCI state or the second downlink TCI state in the second pair of downlink TCI state and uplink TCI state) to the first RS in the first RS set based on the first condition. In some embodiments, a second TCI state may be applied to the second RS. In some embodiments, the second TCI state can be a default TCI state. In some embodiments, the second TCI state may be a fallback TCI state. In other embodiments, the second TCI state may be a downlink TCI state or a joint TCI state or a downlink TCI state of a pair of a downlink TCI state and an uplink TCI state which corresponds to a lowest codepoint from a set of codepoints activated via MAC CE. In some embodiments, the second TCI state may be a previous TCI state (for example, a downlink TCI state or a joint TCI state or a downlink TCI state of a pair of a downlink TCI state and an uplink TCI state) which is applied to the all or a subset of CORESETs before the first TCI state is applied; and a TCI state which is different from the first TCI state.

In some embodiments, the index of the second RS is configured with a same value as the RS index in the RS set indicated by a downlink TCI state or a joint TCI state or a downlink TCI state of a pair of a downlink TCI state and an uplink TCI state which corresponds to a lowest codepoint from a set of codepoints activated via MAC CE.

In some embodiments, the second RS is an RS with the configured index has a same value as the RS index in the RS set indicated by a downlink TCI state or a joint TCI state or a downlink TCI state of a pair of a downlink TCI state and an uplink TCI state which corresponds to a lowest codepoint from a set of codepoints activated via MAC CE.

In some embodiments, the first condition may be at least one of: after a first timing, wherein the first timing may be a beam application timing or a first slot or a first subslot which is at least a first value of milliseconds or a second value of symbols after a last symbol of an uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than or later than a second PDCCH in a set of PDCCHs or the first PDCCH is the latest one in the second of PDCCHs, wherein the HARQ-ACK corresponding to the detected DCI in the first PDCCH or a PDSCH scheduled by the detected DCI in the first PDCCH is ACK, and the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

In some embodiments, the uplink resource may be a resource for PUSCH or a resource for PUCCH. In some embodiments, the terminal device transmits the uplink resource to the network device.

In some embodiments, the terminal device may stop or discard a first procedure based on a second condition. In some embodiments, the first procedure may be a beam failure recovery procedure. In some embodiments, the first procedure may include a beam failure detection procedure and/or a new beam candidate identification procedure. In some embodiments, the terminal device may set the value of a beam failure indication counter (for example, BFI_counter) to 0 based on the second condition. In some embodiments, the terminal device may stop a beam failure recovery timer (for example, beamFailureRecoveryTimer, which is configured by RRC) based on the second condition. In some embodiments, the beam failure indication counter is a non-negative integer.

In some embodiments, the second condition may be at least one of: after a second timing; starting from the second timing; TCI_1 is different from TCI_2; the second joint TCI state is different from the first joint TCI state; the second downlink TCI state is different from the first downlink TCI state; the second pair of downlink TCI state and an uplink TCI state is different from the first pair of downlink TCI state and an uplink TCI state; a hybrid automatic repeat request acknowledgement (HARQ-ACK) corresponding to the detected DCI or a PDSCH scheduled by the DCI is ACK; and the first PDCCH starts or ends no earlier than or later than a second PDCCH in a set of PDCCHs or the first PDCCH is the latest one in the second of PDCCHs, wherein the HARQ-ACK corresponding to the detected DCI in the first PDCCH or a PDSCH scheduled by the detected DCI in the first PDCCH is ACK, and the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

In some embodiments, the second timing is no later or earlier than the first timing. In some embodiments, the second timing may be at least one of: a timing when the DCI is detected in the first PDCCH; a timing when the PDSCH scheduled by the detected DCI is successfully decoded; a timing when the HARQ-ACK corresponding to the DCI or corresponding to the PDSCH scheduled by the detected DCI is encoded; and a timing when the HARQ-ACK corresponding to the DCI or corresponding to the PDSCH scheduled by the detected DCI is generated at the terminal device.

In some embodiment, during a time duration, the beam failure indication counter (for example, BFI_counter) is not increased by 1, even if beam failure instance indication is received from lower layers of the terminal device.

In some embodiments, the beam/TCI state for at least one RS in BFD RS set q0 can be updated after beam application timing in case of dynamic beam indication. Alternatively, the dynamic indicated beam/TCI state (DL TCI or joint TCI) can be updated to RS in BFD RS set and/or can be monitored for beam failure detection after the beam application timing, if the HARQ-ACK corresponding to the DCI or the PDSCH scheduled by the DCI is ACK). For example, as shown in FIG. 3, the PDCCH 310 can indicate the TCI state 1 and the TCI state for BFD RS can be TCI state 2. After the beam application timing 311, the TCI state 1 can be applied to the CORESET. Moreover, after the beam application timing 311, the TCI state for the BFD RS can be updated 305 from the TCI state 2 to the TCI state 1.

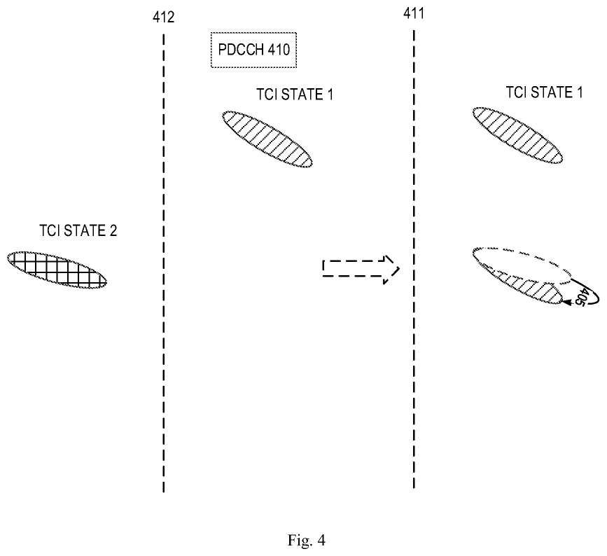

In other embodiments, the current BFR procedure (for example, a beam failure detection and/or a new beam identification) can be stopped after a second timing. The second timing may be when the DCI is detected in the PDCCH or when the PDSCH scheduled by the DCI is successfully decoded, if the indicated TCI state is different from the current TCI state, at least for DL TCI. And after the first timing (i.e., the beam application timing), the BFR procedure is resumed, no matter whether the new TCI state is applied. For example, as shown in FIG. 4, the PDCCH 410 can indicate the TCI state 1 and the TCI state for BFD RS can be TCI state 2. The current BFR procedure can be stopped after the second timing 412. After the first timing 411, the TCI state 1 can be applied to the COREST and the BFR procedure can be resumed. In some embodiments, the TCI state for the BFD RS can be updated 405 from the TCI state 2 to the TCI state 1.

In an example embodiment, if a set q0 of periodic CSI-RS resource configuration indexes is provided, the TCI state (for example, DL TCI or joint TCI) in PDCCH can be applied to the TCI state for at least one CSI-RS resource after beam application timing. For example, in some embodiments, the dynamic indicated beam/TCI state (for example, DL TCI or joint TCI) can be applied to the whole BFD RS set. For example, if q0 is provided to the terminal device 110-1, only 1 RS index is enough. And the beam/TCI state for the RS follows the dynamic indicated beam/TCI state(s) (DL TCI or joint TCI).

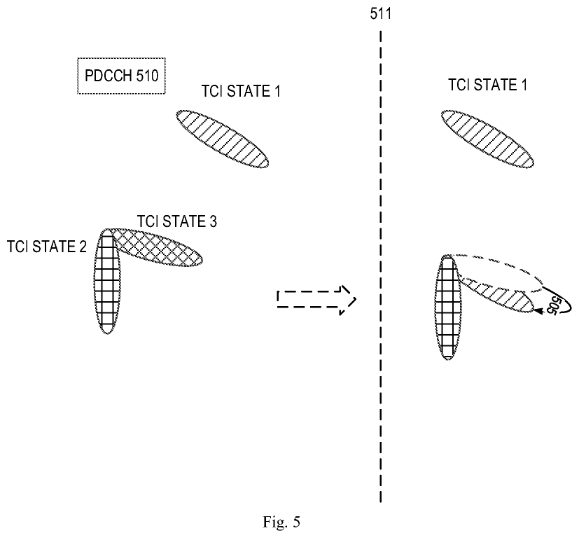

Alternatively, the dynamic indicated beam/TCI state(s) (for example, DL TCI or joint TCI) can be applied to one RS in the BFD RS set. For example, if q0 is provided and 2 RS indexes are included in q0, the dynamic indicated beam/TCI state can be applied to the RS with lower index or higher index. In other embodiments, if q0 is provided and 2 RC indexes are included in q0, the dynamic indicated beam/TCI state can be applied to one of the RS (e.g. RS A), and beam/TCI state(s) for RS B is a fallback/default beam (e.g. TCI state(s) for lowest codepoint). For example, as shown in FIG. 5, the PDCCH 510 can indicate the TCI state 1 and the TCI states for BFD RS can be TCI state 2 and TCI state 3. After the first timing 511, the TCI state 1 can be applied to the COREST. The TCI state 2 for the BFD RS can be maintained and the other TCI state for the BFD RS can be updated 505 from the TCI state 3 to the TCI state 1. In other words, the dynamic indicated TCI state (i.e., the TCI state 1) can be applied to one of the RS (e.g. RS A) and beam/TCI state(s) for RS B is a fallback/default beam which is the TCI state 2 in this case.

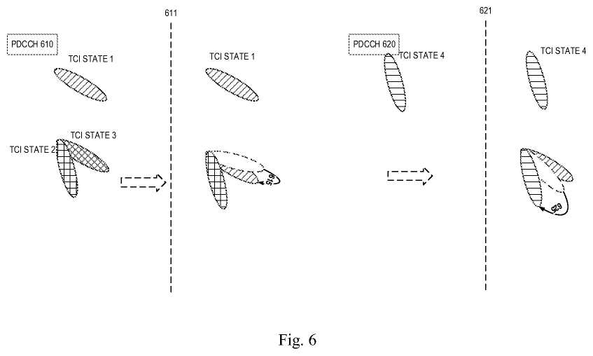

In other embodiments, the dynamic indicated beam/TCI state(s) (for example, DL TCI or joint TCI) can be applied to one of the RS in the BFD RS set alternatively. For example, if q0 is provided and 2 RS indexes are included in q0 (e.g. RS A and RS B), the n-th dynamic indicated beam/TCI state(s) can be applied to the RS A, and the (n+1)-th dynamic indicated beam/TCI state(s) can be applied to RS B after application timing. For example, as shown in FIG. 6, the PDCCH 610 can indicate the TCI state 1 and the TCI states for BFD RS can be TCI state 2 and TCI state 3. After the beam application timing 611, the TCI state 1 can be applied to the COREST. The TCI state 2 for the BFD RS can be maintained and the other TCI state for the BFD RS can be updated 615 from the TCI state 3 to the TCI state 1. The PDCCH 620 can indicate the TCI state 4. After the beam application timing 621, the TCI state 4 can be applied to the COREST. The TCI state 1 for the BFD RS can be maintained and the other TCI state for the BFD RS can be updated 625 from the TCI state 2 to the TCI state 4. In other words, the n-th dynamic indicated beam/TCI state (i.e., the TCI 1) can be applied to the RS A, and the (n+1)-th dynamic indicated beam/TCI state (i.e., the TCI 4) can be applied to RS B after application timing.

Alternatively, if a set q0 of periodic CSI-RS resource configuration indexes is not provided, beam/TCI state(s) for BFD RS at least follows the dynamic indicated beam/TCI state(s). For example, the terminal device 110-1 may determine the BFD RS set to include the CSI-RS configured with QCL TypeD corresponding to the indicated TCI state (DL TCI or joint TCI). In some embodiments, if the terminal device 110-1 is not provided q̅₀̅ by failureDetectionResourceToAddModList for a bandwidth part (BWP) of the serving cell and if the dynamic beam indication is configured, the terminal device 110-1 may determine that the set q̅₀̅ to include periodic channel state information reference signal (CSI-RS) resource configuration indexes with a same value as the RS index configured with qcl-Type set to “TypeD” by TCI-State according to the value of the “Transmission Configuration Indication” field in a detected DCI after the beam application timing and until another beam application timing of a different TCI-State according to the value of the “Transmission Configuration indication” field in another detected DCI. Alternatively, the terminal device 110-1 may determine the set q̅₀̅ to include periodic CSI-RS resource configuration indexes with same values as the RS indexes in the RS sets indicated by TCI-State for respective CORESETs that the terminal device 110-1 can use for monitoring PDCCH until an application timing of a different TCI-State according to the value of the “Transmission Configuration Indication” field in a detected DCI. If there are two RS indexes in a TCI state, the set q̅₀̅ can include RS indexes configured with qcl-Type set to “TypeD” for the corresponding TCI states. The terminal device 110-1 may expect the set q̅₀̅ to include up to two RS indexes and may expect a single port RS in the set q̅₀̅.

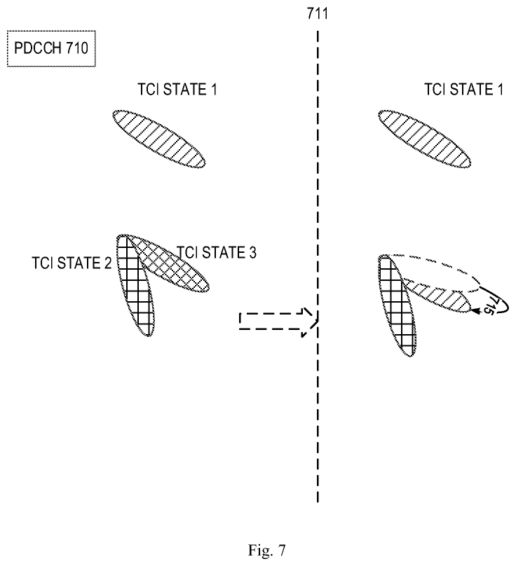

In some embodiments, if a set q0 of periodic CSI-RS resource configuration indexes is not provided, the beam/TCI state(s) for BFD RS at least follows the dynamic indicated beam/TCI state(s). For example, the terminal device 110-1 may determine the BFD RS set to include up to 2 CSI-RS configured with QCL TypeD, and one RS corresponding to the indicated TCI state (for example, DL TCI or joint TCI), and the other RS corresponding to a default/fallback TCI state (for example, DL TCI or joint TCI). For example, as shown in FIG. 7, the PDCCH 710 can indicate the TCI state 1 and the TCI states for BFD RS can be TCI state 2 and TCI state 3. After the first timing 711, the TCI state 1 can be applied to the COREST. The TCI state 2 for the BFD RS can be maintained and the other TCI state for the BFD RS can be updated 715 from the TCI state 3 to the TCI state 1. In other words, the dynamic indicated TCI state (i.e., the TCI state 1) can be applied to one of the RS (e.g. RS A) and beam/TCI state(s) for RS B is a fallback/default beam which is the TCI state 2 in this case.

In other embodiments, after MAC CE activating the TCI state(s) and prior to the beam application timing for the TCI state indicated in DCI, the dynamic indicated beam/TCI state can be replaced by the TCI state(s) for the lowest codepoint. In this way, proper beam failure detection can be processed.

In some embodiments, if the beam(s)/TCI state(s) for at least one BFD RS is updated based on the dynamic indicated beam(s)/TCI states(s) in TCI field in a PDCCH (for example, PDCCH 310, PDCCH 410, PDCCH 510, or PDCCH 710), the BFI_counter can be set to 0. For example, if TCI state(s) of any of the reference signals used for beam failure detection is indicated/updated by DCI/physical layer with a condition associated with this Serving Cell, the BFI_counter can be set to 0. In some embodiments, the condition may be the HARQ-ACK corresponding to the DCI or the PDSCH scheduled by the DCI is ACK. Alternatively, the condition can be that the PDCCH with the DCI is the latest one in case of HARQ-ACK multiplexing. In other embodiments, the condition may be after a timing, for example, the beam application timing or the timing when the DCI is detected or the PDSCH scheduled by the DCI is successfully decoded or the HARQ-ACK codebook is generated.

In some embodiments, the terminal device may be configured or the terminal device may determine two RS sets (for example, RS_s1 and RS_s2) for beam failure detection. In some embodiments, RS_s1 may include one or two RS or include index(es) of the one or two RS. In some embodiments, RS_s2 may include one or two RS or the index(es) of the one or two RS. In some embodiments, the terminal device may be configured with multi-TRP transmission (for example, a first TRP and a second TRP). In some embodiments, RS_s1 may be applied for beam failure detection for the first TRP. In some embodiments, RS_s2 may be applied for beam failure detection for the second TRP. In some embodiments, there may be a first beam failure recovery procedure for the first TRP. In some embodiments, there may be a second beam failure recovery procedure for the second TRP. In some embodiments, there may be a third beam failure recovery procedure for the cell of the first TRP and the second TRP. In some embodiments, when any one of the value of beam failure indication counter is set to 0 in the first beam failure recovery procedure or in the second beam failure recovery procedure, the value of beam failure indication counter in the third beam failure recovery procedure is set to 0. In some embodiments, when any one of the beam failure recovery timer (for example, beamFailureRecoveryTimer, which is configured by RRC) in the first beam failure recovery procedure or in the second beam failure recovery procedure is stopped, the beam failure recovery timer (for example, beamFailureRecoveryTimer, which is configured by RRC) in the third beam failure recovery procedure is stopped.

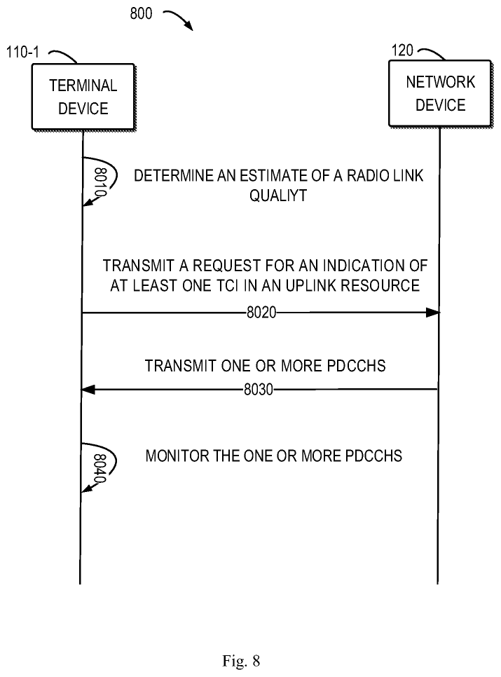

FIG. 8 illustrates a signaling chart for communication between network device and terminal device in accordance with some embodiments of the present disclosure. For the purpose of discussion, the process 800 will be described with reference to FIG. 1. The process 800 may involve the network device 120 and the terminal device 110-1 as shown in FIG. 1.

The terminal device 110-1 determines 8010 an estimation of a radio link quality between the terminal device 110-1 and the network device 120 according to a first RS and a second RS. For example, the terminal device 110-1 can measure the first set of RSs. In this case, the terminal device 110-1 can estimate the radio link quality based on the measurement results of the first set of RS.

The terminal device 110-1 transmits 8020 a request for an indication of at least one TCI state in an uplink resource to the network device 120. The request may not comprise an index of RS. In this case, the terminal device 110-1 may receive DCI in a first PDCCH from the network device 120. The DCI can comprise the indication of the at least one TCI state. The terminal device 110-1 may further apply the at least one TCI state to the first RS based on a first condition. In some embodiments, the at least one TCI state or the second TCI state can be applied for transmission of the uplink resource. For example, in some embodiments, up to 2 RS indexes included in q0 (e.g. RS A and RS B), the dynamic indicated beam/TCI state(s) can be applied to RS A, and default/fallback beam/TCI state(s) can be applied to RS B. If a failure (e.g. represented as a first failure or a single failure) is detected based on RS A and the beam failure is not detected based on RS A+RS B (for example, beam failure recovery request is not triggered), the terminal device 110-1 may report a beam indication request to the network device 120 (e.g. via PUCCH/PRACH/PUSCH, and the beam or spatial relation information can follow a default/fallback UL TCI).

The network device 120 transmits 8030 one or more PDCCHs in the one or more CORESETs to the terminal device 110-1. The terminal device 110-1 monitors 8040 the one or more PDCCHs in one or more CORESETs based on a condition. In some embodiments, the condition may comprise that a failure is detected based on the first RS. Alternatively or in addition, the condition may comprise that a failure is not detected based on the second RS. In some embodiments, the terminal device 110-1 may monitor PDCCH in CORESETs with the default/fallback beam/TCI state after the request (e.g. until beam/TCI state(s) is indicated in a PDCCH and after application timing).

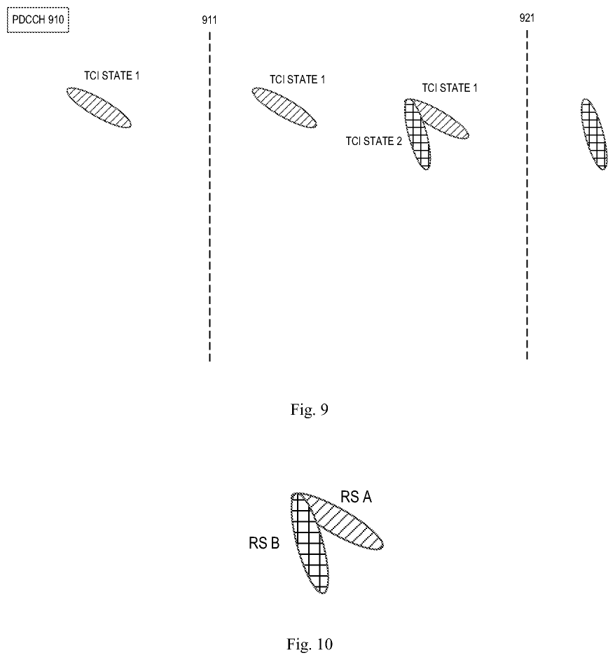

In some embodiments, a second TCI state may be applied to the second RS. For example, the second TCI can be a default TCI state. Alternatively, the second TCI may be a fallback TCI state. In other embodiments, the second TCI may be a TCI state which corresponds to a lowest codepoint from a set of codepoints activated via MAC CE. Alternatively, the second TCI may be a TCI state which is applied to the first PDCCH. In this case, the terminal device 110-1 may receive/monitor the one or more PDCCHs in one or more CORESETs with the second TCI state. The terminal device 110-1 may transmit PUSCH/PUCCH using a same spatial domain filter as the one corresponding RS B after the request. For example, as shown in FIG. 9, the PDCCH 910 can indicate the TCI state 1. The TCI state 1 can be applied to RS A after the beam application timing 911. The TCI state 2 which is the default/fallback TCI state can be applied to RS B. If a failure is detected based on RS A (in other words, the TCI state 1 is not valid) and the beam failure is not detected based on RS A+RS B (for example, beam failure recovery request is not triggered), the terminal device 110-1 may report the beam indication request to the network device 120 at the timing 921. In this case, the terminal device 110-1 may receive/monitor the one or more PDCCHs in one or more CORESETs with the TCI state 2.

In some embodiments, the terminal device 110-1 can transmit the request with a beam/TCI state. In some embodiments, the beam/TCI state can be the default/fallback beam/TCI state (e.g. joint or UL TCI) or the indicated (current applied) UL TCI. Alternatively, the terminal device 110-1 can transmit the request with an indicated (i.e., currently applied) UL TCI, if a separate TCI is configured to the terminal device 110-1. In some embodiments, if a joint TCI is configured to the terminal device 110-1, the terminal device 110-1 may transmit the request with default/fallback beam/(joint) TCI state(s).

In some embodiments, the request may comprise an indication of beam update/indication request. For example, the request may comprise one bit to indicate the beam update/indication request. In this case, if the network device 120 receives the request, the network device 120 may know that the terminal device 110-1 needs to be indicated/updated with a (new/different) beam. Within the request, there is no need to report new candidate beam. In some embodiments, the terminal device 110-1 doesn't need to search new candidate beam after beam failure detected on RS A.

In other embodiments, a separate procedure and/or a separate set of parameters (e.g. at least one of beamFailureDetectionTimer_1, BFI_COUNTER_1, beamFailureInstanceMaxCount_1, beamFailureRecoveryTimer_1 (or beamUpdateRequestTimer)) for beam failure detection on RS A and beam change/update request based on the detection can be proposed. For example, as shown in FIG. 10, a first beam failure is detected on the RS A. Table 1 shows an example of a first procedure of failure detection at the MAC entity of the terminal device 110-1.

TABLE 1

| 1> | if a first failure instance indication (a first failure is detected based on RS A) has been received from | |
|---|---|---|
| | lower layers: | |
| | 2> | start or restart the beamFailureDetectionTimer_1; |
| | 2> | increment BFI_COUNTER_1 by 1; |
| | 2> | if BFI_COUNTER_1 >= beamFailureInstanceMaxCount_1: |
| | 2> | trigger a beam update/indication request for this serving cell. |
| 1> | if the beamFailureDetectionTimer_1 expires; or | |
| 1> | if beamFailureDetectionTimer_1, beamFailureInstanceMaxCount_1, or RS A is reconfigured by | |
| | upper layers or beam/TCI state(s) of RS A is updated by physical layer associated with this Serving | |
| | Cell: | |
| | 2> | set BFI_COUNTER to 0; |
| | 2> | set BFI_COUNTER_1 to 0. |
| 1> | if a PDCCH addressed to C-RNTI or CS-RNTI indicating TCI state(s) is received (after | |
| | transmission of the beam update/indication request): | |
| | 2> | set BFI_COUNTER_1 to 0; |
| | 2> | set BFI COUNTER to 0 (beam failure procedure is stopped or restarted); |
| | 2> | stop the beamFailureRecoveryTimer_1 or beamUpdateRequestTimer, if configured; |
| | 2> | consider the first failure procedure successfully completed. |

Moreover, as shown in FIG. 10, the terminal device 110-1 may perform the beam failure detection on the RS A and RS B. Table 2 shows an example of a failure detection and recovery procedure at the MAC entity of the terminal device 110-1.

TABLE 2

| 1> | if beam failure instance indication has been received from lower layers: | |
|---|---|---|
| | 2> | start or restart the beamFailureDetectionTimer; |
| | 2> | increment BFI_COUNTER by 1; |
| | 2> | if BFI_COUNTER >= beamFailureInstanceMaxCount: |

| | |
|---|---|
| 3> | stop the first failure procedure (e.g. set BFI_COUNTER_1 to 0); |
| 3> | if the Serving Cell is SCell: |

| | |
|---|---|
| 4> | trigger a BFR for this Serving Cell; |

| | |
|---|---|
| 3> | else: |

| | |
|---|---|
| 4> | initiate a Random Access procedure (see clause 5.1) on the SpCell. |

| 1> | if the beamFailureDetectionTimer expires; or | |
|---|---|---|
| 1> | if beamFailureDetectionTimer, beamFailureInstanceMaxCount, or any of the reference signals used | |
| | for beam failure detection is reconfigured by upper layers associated with this Serving Cell: | |
| | 2> | set BFI_COUNTER_1 to 0; |
| | 2> | set BFI_COUNTER to 0. |
| 1> | if the Serving Cell is SpCell and the Random Access procedure initiated for SpCell beam failure | |
| | recovery is successfully completed (see clause 5.1): | |
| | 2> | set BFI_COUNTER_1 to 0; |
| | 2> | set BFI_COUNTER to 0; |
| | 2> | stop the beamFailureRecoveryTimer, if configured; |
| | 2> | consider the Beam Failure Recovery procedure successfully completed. |
| 1> | else if the Serving Cell is SCell, and a PDCCH addressed to C-RNTI indicating uplink grant for a | |
| | new transmission is received for the HARQ process used for the transmission of the BFR MAC CE | |
| | or Truncated BFR MAC CE which contains beam failure recovery information of this Serving Cell; | |
| | or | |
| 1> | if the SCell is deactivated as specified in clause 5.9: | |
| | 2> | set BFI_COUNTER_1 to 0; |
| | 2> | set BFI_COUNTER to 0; |
| | 2> | consider the Beam Failure Recovery procedure successfully completed and cancel all the |
| | | triggered BFRs for this Serving Cell. |
| 1> | if the Beam Failure Recovery procedure determines that at least one BFR has been triggered and not | |
| | cancelled for an SCell for which evaluation of the candidate beams according to the requirements as | |
| | specified in TS 38.133 [11] has been completed: | |
| | 2> | if UL-SCH resources are available for a new transmission and if the UL-SCH resources can |

| accommodate the BFR MAC CE plus its subheader as a result of LCP: | |
|---|---|
| 3> | instruct the Multiplexing and Assembly procedure to generate the BFR MAC CE. |

| | |
|---|---|
| 2> | else if UL-SCH resources are available for a new transmission and if the UL-SCH resources can |

| accommodate the Truncated BFR MAC CE plus its subheader as a result of LCP: | |
|---|---|
| 3> | instruct the Multiplexing and Assembly procedure to generate the Truncated BFR MAC CE. |

| | |
|---|---|
| 2> | else: |

| | |
|---|---|
| 3> | trigger the SR for SCell beam failure recovery for each SCell for which BFR has been triggered, |

not cancelled, and for which evaluation of the candidate beams according to the requirements as
specified in TS 38.133 [11] has been completed.

In some embodiments, after BFR, the new identified beam can be applied to monitor PDCCH in CORESETs and/or transmit PUCCH and the TCI field in the PDCCH can be ignored. For the PCell or the PSCell, the terminal device 110-1 can be provided a configuration for PRACH transmission. For PRACH transmission in slot n and according to antenna port quasi co-location parameters associated with periodic CSI-RS resource configuration or with synchronization signal/physical broadcast channel (SS/PBCH) block associated with index q_{new} provided by higher layers, the terminal device 110-1 may monitor PDCCH in a search space set provided by recoverySearchSpaceId for detection of a DCI format with CRC scrambled by a cell radio network temporary identity (C-RNTI) or a modulation coding sachem cell-RNTI (MCS-C-RNTI) starting from slot n+4 within a window configured by BeamFailureRecoveryConfig. For PDCCH monitoring in a search space set provided by recoverySearchSpaceId and for corresponding PDSCH reception, the terminal device 110-1 may assume the same antenna port quasi-collocation parameters as the ones associated with index q_{new} and the TCI field, if present in a detected DCI, is ignored if dynamic beam indication is configured until the UE receives by higher layers an activation for a TCI state or any of the parameters tci-StatesPDCCH-ToAddList and/or tci-StatesPDCCH-ToReleaseList. After the terminal device 110-1 detects a DCI format with CRC scrambled by C-RNTI or MCS-C-RNTI in the search space set provided by recoverySearchSpaceId, the terminal device 110-1 may continue to monitor PDCCH candidates in the search space set provided by recoverySearchSpaceId until the terminal device 110-1 receives a MAC CE activation command for a TCI state or tci-StatesPDCCH-ToAddList and/or tci-StatesPDCCH-ToReleaseList.

For the PCell or the PSCell, after 28 symbols from a last symbol of a first PDCCH reception in a search space set provided by recoverySearchSpaceId for which the terminal device 110-1 detects a DCI format with CRC scrambled by C-RNTI or MCS-C-RNTI, and the TCI field, if present in a detected DCI, is ignored if dynamic beam indication is configured and until the terminal device 110-1 receives an activation command for PUCCH-SpatialRelationInfo [11, TS 38.321] or is provided PUCCH-SpatialRelationInfo for PUCCH resource(s) or receives an activation command for TCI state(s) if dynamic beam indication is configured, the terminal device 110-1 transmits a PUCCH on a same cell as the PRACH transmission using
a same spatial filter as for the last PRACH transmission
a power determined as described in Clause 7.2.1 with q_{w}=0, q_{d}=q_{new}, and l=0.

For the PCell or the PSCell, after 28 symbols from a last symbol of a first PDCCH reception in a search space set provided by recoverySearchSpaceId where the terminal device 110-1 detects a DCI format with CRC scrambled by C-RNTI or MCS-C-RNTI, the terminal device 110-1 assumes same antenna port quasi-collocation parameters as the ones associated with index q_{new} for PDCCH monitoring in a CORESET with index 0, and the TCI field, if present in the detected DCI format, is ignored if dynamic beam indication is configured.

For the PCell or the PSCell, if BFR MAC CE [11, TS38.321] is transmitted in Msg3 or MsgA of contention based random access procedure, and if a PUCCH resource is provided with PUCCH-SpatialRelationInfo, after 28 symbols from the last symbol of the PDCCH reception that determines the completion of the contention based random access procedure as described in Clause 5.1.5 of [11, TS38.321], the terminal device 110-1 transmits the PUCCH on a same cell as the PRACH transmission using
a same spatial filter as for the last PRACH transmission
a power determined as described in Clause 7.2.1 with q_{w}=0, q_{d}=q_{new}, and l=0, where qnew is the SS/PBCH block index selected for the last PRACH transmission.

The terminal device 110-1 can be provided, by schedulingRequestID-BFR-SCell, a configuration for PUCCH transmission with a link recovery request (LRR) as described in Clause 9.2.4. The terminal device 110-1 can transmit in a first PUSCH MAC CE providing index(es) for at least corresponding SCell(s) with radio link quality worse than Qout,LR, indication(s) of presence of q_{new} for corresponding SCell(s), and index(es) q_{new} for a periodic CSI-RS configuration or for a SS/PBCH block provided by higher layers, as described in [11, TS 38.321], if any, for corresponding SCell(s). After 28 symbols from a last symbol of a PDCCH reception with a DCI format scheduling a PUSCH transmission with a same HARQ process number as for the transmission of the first PUSCH and having a toggled NDI field value, the terminal device 110-1 may
monitor PDCCH in all CORESETs on the SCell(s) indicated by the MAC CE using the same antenna port quasi co-location parameters as the ones associated with the corresponding index(es) q_{new}, if any,
transmit PUCCH on a PUCCH-SCell using a same spatial domain filter as the one corresponding to q_{new}, if any, for periodic CSI-RS or SS/PBCH block reception, as described in Clause 9.2.2, and using a power determined as described in Clause 7.2.1 with qᵤ=0, q_{d}=q_{new}, and l=0, if
the terminal device 110-1 is provided PUCCH-SpatialRelationInfo for the PUCCH,
a PUCCH with the LRR was either not transmitted or was transmitted on the PCell or the PSCell, and
the PUCCH-SCell is included in the SCell(s) indicated by the MAC-CE
until the UE receives an activation command for TCI state(s) in higher layer if dynamic beam indication is configured, and the TCI field, if present in a detected DCI, is ignored, if dynamic beam indication is configured. The SCS configuration for the 28 symbols is the smallest of the SCS configurations of the active DL BWP for the PDCCH reception and of the active DL BWP(s) of the at least one SCell.

In some embodiments, in case of cross component carrier (CC) indication (for example, the terminal device 110-1 receives PDCCH in CC1 and the detected DCI indicates TCI state(s) and cross carrier scheduling/indication on CC2), if the indicated TCI state is a joint TCI or a pair of DL TCI+UL TCI, and if the CC2 is a downlink CC without uplink transmission, the joint TCI is only applied or only DL TCI is applied to downlink transmission (CORESET, PDSCH, and RS). The TCI state pool across CC can be applied to a set of CCs, and if a CC in the set is a downlink only CC (without uplink), then if the TCI state is joint TCI, it's only applied to the downlink transmission on the CC, and if the TCI state is a pair of DL TCI+UL TCI, only the DL TCI is applied to the CC. For example, the terminal device 110-1 does not expect to be indicated with only a UL TCI to the CC. Alternatively, if the terminal device 110-1 is indicated with a UL TCI to the CC, the current or default DL TCI is applied to the CC.

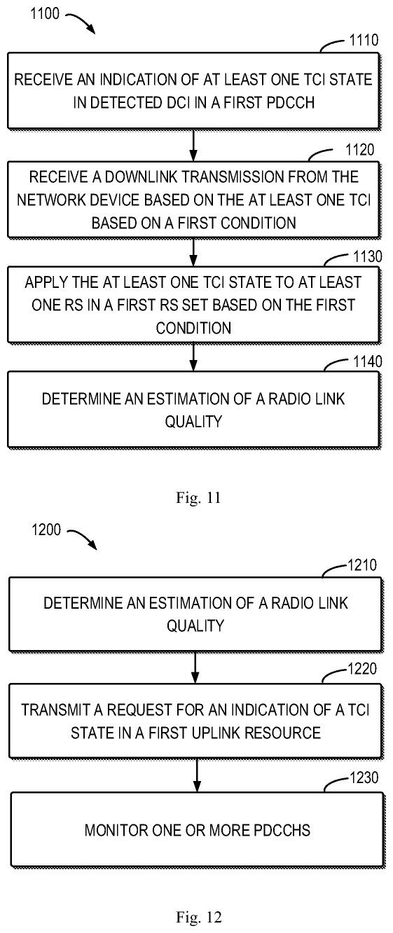

FIG. 11 shows a flowchart of an example method 1100 in accordance with an embodiment of the present disclosure. Only for the purpose of illustrations, the method 1100 can be implemented at a terminal device 110-1 as shown in FIG. 1.

At block 1110, the terminal device 110-1 receives, from the network device 120, an indication of at least one transmission configuration indicator (TCI) state in a detected downlink control information (DCI) in a first physical downlink control channel (PDCCH).

At block 1120, the terminal device 110-1 receives a downlink transmission from the network device 120 based on the at least one TCI state based on a first condition. In some embodiments, the first condition comprises one or more of: after a first timing; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource. In some embodiments, the first timing is a beam application timing.

At block 1130, the terminal device 110-1 applies the at least one TCI state to at least one reference signal (RS) in a first RS set based on the first condition or includes a third RS which is indicated by the at least one TCI state into the first RS set based on the first condition. The first RS set is applied for beam failure detection. In some embodiments, the terminal device 110-1 may stop a first procedure based on a second condition. The terminal device 110-1 may resume a second procedure based on the first condition. In this case, the second condition comprises at least one of: after a second timing; starting from the second timing; the at least one TCI state is different from the a first TCI state, wherein the first TCI state is applied to a PDCCH for the detected DCI and/or applied to the at least one RS in the first RS set; a hybrid automatic repeat request acknowledgement (HARQ-ACK) corresponding to the detected DCI or a PDSCH scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the any other PDCCH are reported to the network device in a same resource.

In some embodiments, the terminal device 110-1 may transmit the uplink resource with the acknowledgement to the network device, wherein the uplink resource is a resource for physical uplink shared channel (PUSCH) or a resource for physical uplink control channel (PUCCH).

In an example embodiment, the second timing is no later or earlier than the first timing. The second timing may comprise at least one of: a timing when the DCI is detected in the first PDCCH; a timing when the PDSCH scheduled by the detected DCI is successfully decoded; and a timing when the HARQ-ACK corresponding to the DCI or corresponding to the PDSCH scheduled by the detected DCI is generated at the terminal device. In some embodiments, the first RS set comprises one or two RSs.

In some embodiments, the terminal device 110-1 may apply the at least one TCI state to a first RS in the first RS set based on the first condition and apply a second TCI state to a second RS in the first RS set, and wherein the first RS set comprises the first RS and the second RS.

In an example embodiment, the first RS is an RS with lower or higher value of index in the first RS set. In other example embodiments, the second TCI state is a default or fallback TCI state or a TCI state corresponding to a lowest codepoint from a set of codepoints activated via medium access control control element (MAC CE).

In some embodiments, the second TCI state is the first TCI state. In some embodiments, the first RS set is configured from the network device. In some embodiments, the first RS set is determined at the terminal device, based on a TCI state for one or more control resource sets (CORESETs).

In an example embodiment, a value of a beam failure indication counter is set to 0 based on a second condition. The second condition can comprise at least one of: after a second timing; starting from the second timing; the at least one TCI state is different from the a first TCI state, wherein the first TCI state is applied to a PDCCH for the detected DCI and/or applied to the at least one RS in the first RS set; a hybrid automatic repeat request acknowledgement (HARQ-ACK) corresponding to the detected DCI or a PDSCH scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the any other PDCCH are reported to the network device in a same resource.

In some embodiments, the terminal device 110-1 may ignore a TCI field in another detected DCI in another PDCCH after a third timing and/or until a fourth timing. In this case, the third timing is when a beam failure recovery is successfully completed and the fourth timing is when one or more TCI states are activated or when an indicated mapping between TCI states and codepoints is applied.

In some embodiments, the terminal device 110-1 may replace the first RS with the third RS in the first RS set based on the first condition and apply the second TCI state to the second RS in the first RS set. In this case, the first RS set comprises the first RS and the second RS.

At block 1140, the terminal device 110-1 determines an estimation of a radio link quality between the terminal device and the network device based on the first RS set.

FIG. 12 shows a flowchart of an example method 1200 in accordance with an embodiment of the present disclosure. Only for the purpose of illustrations, the method 1200 can be implemented at a terminal device 110-1 as shown in FIG. 1.

At block 1210, the terminal device 110-1 determines an estimation of a radio link quality according to a first reference signal (RS) and a second RS.

At block 1220, the terminal device 110-1 transmits, to the network device 120, a request for an indication of a transmission configuration indicator (TCI) state in a first uplink resource based on a first situation. In some embodiments, the first situation comprises at least one of: a failure detected based on the first RS; and a failure not detected based on the second RS. In some embodiments, the request does not comprise an index of RS.

In an example embodiment, the terminal device 110-1 receives, from the network device 120, an indication of a TCI state in downlink control information (DCI) in a first PDCCH. The terminal device 110-1 may also apply the TCI state to the first RS based on a first condition. The first condition can comprise at least one of: after a first timing, wherein the first timing is a beam application timing or a first slot or a first subslot which is at least a first value of milliseconds or a second value of symbols after a last symbol of a second uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource. The terminal device 110-1 can apply a second TCI state to the second RS. The second TCI state can comprise one of: a default TCI state; a fallback TCI state; a TCI state corresponding to a lowest codepoint from a set of codepoints activated via medium access control control element (MAC CE); or a TCI state which is applied to the first PDCCH.

At block 1230, the terminal device 110-1 monitors one or more physical downlink control channels (PDCCHs) in one or more control resource sets (CORESETs). In some embodiments, the terminal device 110-1 may monitor one or more PDCCH in one or more CORESETs with the second TCI state. The TCI state can be applied for transmission of the uplink resource. In some embodiments, the second TCI state or an uplink TCI state is applied for transmission of the first uplink resource, wherein the uplink TCI state is a TCI state which is applied for uplink transmission at the time of the transmission of the first uplink resource.

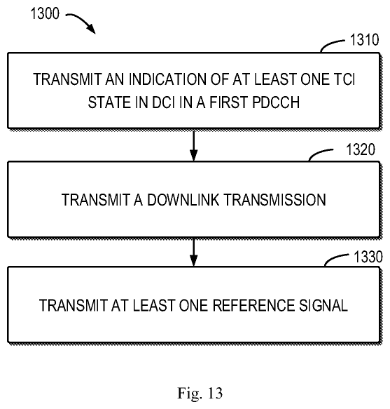

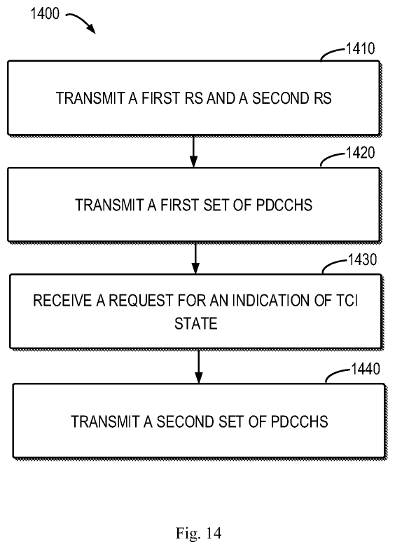

FIG. 13 shows a flowchart of an example method 1300 in accordance with an embodiment of the present disclosure. Only for the purpose of illustrations, the method 1300 can be implemented at a network device 120 as shown in FIG. 1.

At block 1310, the network device 120 transmits, to the terminal device 110-1, an indication of at least one transmission configuration indicator (TCI) state in downlink control information (DCI) in a first physical downlink control channel (PDCCH).

At block 1320, the network device 120 transmits, to the terminal device 110-1, a downlink transmission from the network device based on the at least one TCI state based on a first condition. In some embodiments, the first condition can comprise at least one of: after a first timing, where the first timing is a beam application timing or a first slot which is at least a first value of milliseconds or a second value of symbols after a last symbol of an uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

At block 1330, the network device 120 transmits at least one reference signal (RS) in a first RS set based on the first condition. The first RS set can be applied for beam failure detection.

In some embodiments, the first timing can be a beam application timing. The first RS set comprises one or two RSs. In some embodiments, the first RS set is configured to the terminal device. In an example embodiment, the first RS set is determined at the terminal device, based on a TCI state for one or more control resource sets (CORESETs).

In some embodiments, the network device 120 may receive the uplink resource with the acknowledgement to the network device. In this case, the uplink resource may be a resource for physical uplink shared channel (PUSCH) or a resource for physical uplink control channel (PUCCH).

FIG. 14 shows a flowchart of an example method 1400 in accordance with an embodiment of the present disclosure. Only for the purpose of illustrations, the method 1400 can be implemented at a network device 120 as shown in FIG. 1.

At block 1410, the network device 120 transmits, to the terminal device 110-1, a first reference signal (RS) and a second RS.

At block 1420, t the network device 120 transmits, to the terminal device 110-1, a first set of PDCCHs in one or more control resource sets (CORESETs) with a third TCI state.

At block 1430, the network device 120 receives, from the terminal device 110-1, a request for an indication of transmission configuration indicator (TCI) state in an uplink resource.

At block 1440, the network device 120 transmits, to the terminal device 110-1, to the terminal device, a second set of PDCCHs in the one or more CORESETs with a fourth TCI state based on the reception of the request. In some embodiments, the fourth TCI state is one of: a default TCI state; a fallback TCI state; a TCI state corresponding to a lowest codepoint from a set of codepoints activated via medium access control control element (MAC CE); a previous TCI state which is applied to the one or more CORESETs before the third TCI state is applied; or a TCI state which is different from the third TCI state.

In some embodiments, the network device 120 may transmit, to the terminal device 110-1, an indication of a fifth TCI state in the second set of PDCCHs. In other embodiments, the network device 120 may transmit, to the terminal device 110-1, transmitting, the second set of PDCCHs with the fourth TCI state after a time duration starting from the first symbol or the last symbol of the uplink resource. In this case, the second TCI state can be one of: a default TCI state; a fallback TCI state; a TCI state corresponding to a lowest codepoint from a set of codepoints activated via medium access control control element (MAC CE); or a TCI state which is applied to the first PDCCH. In some embodiments, the third TCI state and the fifth TCI state correspond to different codepoints in a set of codepoints activated via medium access control control element (MAC CE). In some embodiments, the third TCI state or the fourth TCI state can be applied for transmission of the uplink resource. In an example embodiment, the request does not comprise an index of RS.

In some embodiments, a terminal device comprises circuitry configured to receive, from a network device, an indication of at least one transmission configuration indicator (TCI) state in a detected downlink control information (DCI) in a first physical downlink control channel (PDCCH); receive a downlink transmission from the network device based on the at least one TCI state based on a first condition; apply the at least one TCI state to at least one reference signal (RS) in a first RS set based on the first condition, or include a third RS which is indicated by the at least one TCI state into the first RS set based on the first condition, wherein the first RS set is applied for beam failure detection; and determine an estimation of a radio link quality between the terminal device and the network device based on the first RS set.

In some embodiments, the first condition comprises at least one of: after a first timing, wherein the first timing is a beam application timing or a first slot or a first subslot which is at least a first value of milliseconds or a second value of symbols after a last symbol of an uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

In some embodiments, the terminal device comprises circuitry configured to transmit the uplink resource with the acknowledgement to the network device, wherein the uplink resource is a resource for physical uplink shared channel (PUSCH) or a resource for physical uplink control channel (PUCCH).

In some embodiments, the terminal device comprises circuitry configured to stop a first procedure based on a second condition; and resume a second procedure based on the first condition.

In some embodiments, the second condition comprises at least one of: after a second timing; starting from the second timing; the at least one TCI state is different from the a first TCI state, wherein the first TCI state is applied to a PDCCH for the detected DCI and/or applied to the at least one RS in the first RS set; a hybrid automatic repeat request acknowledgement (HARQ-ACK) corresponding to the detected DCI or a PDSCH scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the any other PDCCH are reported to the network device in a same resource.

In some embodiments, the second timing is no later or earlier than the first timing.

In some embodiments, the second timing comprises at least one of: a timing when the DCI is detected in the first PDCCH; a timing when the PDSCH scheduled by the detected DCI is successfully decoded; and a timing when the HARQ-ACK corresponding to the DCI or corresponding to the PDSCH scheduled by the detected DCI is generated at the terminal device.

In some embodiments, the first RS set comprises one or two RSs or the first RS set comprises one or two indexes of RS resource configuration of the one or two RSs.

In some embodiments, the terminal device comprises circuitry configured to apply the at least one TCI state to a first RS in the first RS set based on the first condition; and apply a second TCI state to a second RS in the first RS set, and wherein the first RS set comprises the first RS and the second RS.

In some embodiments, the terminal device comprises circuitry configured to: replace the first RS with the third RS in the first RS set based on the first condition; and apply the second TCI state to the second RS in the first RS set, and wherein the first RS set comprises the first RS and the second RS.

In some embodiments, the first RS is an RS with lower or higher value of index in the first RS set.

In some embodiments, the second TCI state is a default or fallback TCI state or a TCI state corresponding to a lowest codepoint from a set of codepoints activated via medium access control control element (MAC CE).

In some embodiments, the second TCI state is the first TCI state.

In some embodiments, the first RS set is configured from the network device, or the first RS set is determined at the terminal device, based on a TCI state for one or more control resource sets (CORESETs).

In some embodiments, a value of a beam failure indication counter is set to 0 based on a second condition, the second condition comprises at least one of: after a second timing; starting from the second timing; the at least one TCI state is different from the a first TCI state, wherein the first TCI state is applied to a PDCCH for the detected DCI and/or applied to the at least one RS in the first RS set; a hybrid automatic repeat request acknowledgement (HARQ-ACK) corresponding to the detected DCI or a PDSCH scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the any other PDCCH are reported to the network device in a same resource.

In some embodiments, the terminal device comprises circuitry configured to ignore a TCI field in another detected DCI in another PDCCH after a third timing and/or until a fourth timing.

In some embodiments, the third timing is when a beam failure recovery is successfully completed; and the fourth timing is when one or more TCI states are activated or when an indicated mapping between TCI states and codepoints is applied.

In some embodiments, a terminal device comprises circuitry configured to determine an estimation of a radio link quality according to a first reference signal (RS) and a second RS; transmit, to a network device, a request for an indication of a transmission configuration indicator (TCI) state in a first uplink resource based on a first situation; and monitor one or more physical downlink control channels (PDCCHs) in one or more control resource sets (CORESETs).

In some embodiments, the first situation comprises at least one of: a failure detected based on the first RS; and a failure not detected based on the second RS.

In some embodiments, the terminal device comprises circuitry configured to receive, at the terminal device and from the network device, an indication of a TCI state in a detected downlink control information (DCI) in a first PDCCH; apply the TCI state to the first RS based on a first condition, wherein the first condition comprises at least one of: after a first timing, wherein the first timing is a beam application timing or a first slot or a first subslot which is at least a first value of milliseconds or a second value of symbols after a last symbol of a second uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

In some embodiments, the terminal device comprises circuitry configured to apply a second TCI state to the second RS, the second TCI state is one of: a default TCI state; a fallback TCI state; a TCI state corresponding to a lowest codepoint from a set of codepoints activated via medium access control control element (MAC CE); or a TCI state which is applied to the first PDCCH.

In some embodiments, the terminal device comprises circuitry configured to monitor one or more PDCCH in one or more CORESETs with the second TCI state.

In some embodiments, the second TCI state or an uplink TCI state is applied for transmission of the first uplink resource, wherein the uplink TCI state is a TCI state which is applied for uplink transmission at the time of the transmission of the first uplink resource.

In some embodiments, the request does not comprise an index of RS.

In some embodiments, a network device comprises circuitry configured to transmit an indication of at least one transmission configuration indicator (TCI) state in downlink control information (DCI) in a first physical downlink control channel (PDCCH); transmit, to the terminal device, a downlink transmission from the network device based on the at least one TCI state based on a first condition; and transmit at least one reference signal (RS) in a first RS set based on the first condition, wherein the first RS set is applied for beam failure detection.

In some embodiments, the first condition comprises at least one of: after a first timing, wherein the first timing is a beam application timing or a first slot which is at least a first value of milliseconds or a second value of symbols after a last symbol of an uplink resource with an acknowledgement of the detected DCI or a PDSCH scheduled by the DCI; starting from the first timing; a hybrid automatic repeat request acknowledgement (HARQ-ACK) corresponding to the detected DCI or a physical downlink shared channel (PDSCH) scheduled by the DCI is ACK; and the first PDCCH starts or ends no earlier than a second PDCCH in a set of PDCCHs, wherein the HARQ-ACK corresponding to the detected DCI in the first PDCCH or a PDSCH scheduled by the detected DCI in the first PDCCH and the HARQ-ACK corresponding to a detected DCI in the second PDCCH are reported to the network device in a same resource.

In some embodiments, the network device comprises the circuitry configured to receive, from the terminal device, the uplink resource with the acknowledgement to the network device, wherein the uplink resource may be a resource for physical uplink shared channel (PUSCH) or a resource for physical uplink control channel (PUCCH).

In some embodiments, the first RS set comprises one or two RSs or the first RS set comprises one or two indexes of RS resource configuration of the one or two RSs.

In some embodiments, the first RS set is configured to the terminal device.

In some embodiments, the first RS set is determined at the terminal device, based on a TCI state for one or more control resource sets (CORESETs).

In some embodiments, a network device comprises circuitry configured to transmit, to a terminal device, a first reference signal (RS) and a second RS; transmit, to the terminal device, a first set of physical downlink control channels (PDCCHs) in one or more control resource sets (CORESETs) with a third TCI state; receive, from the terminal device, a request for an indication of transmission configuration indicator (TCI) state in an uplink resource; and transmit, to the terminal device, a second set of PDCCHs in the one or more CORESETs with a fourth TCI state based on the reception of the request.

In some embodiments, the fourth TCI state is one of: a default TCI state; a fallback TCI state; a TCI state corresponding to a lowest codepoint from a set of codepoints activated via medium access control control element (MAC CE); a previous TCI state which is applied to the one or more CORESETs before the third TCI state is applied; or a TCI state which is different from the third TCI state.

In some embodiments, the network device comprises circuitry configured to transmit, to the terminal device, an indication of a fifth TCI state in the second set of PDCCHs.

In some embodiments, a network device comprises circuitry configured to transmit transmitting the second set of PDCCHs with the fourth TCI state based on the reception of the request by transmitting, the second set of PDCCHs with the fourth TCI state after a time duration starting from the first symbol or the last symbol of the uplink resource.

In some embodiments, the third TCI state and the fifth TCI state correspond to different codepoints in a set of codepoints activated via medium access control control element (MAC CE).

In some embodiments, the third TCI state or the fourth TCI state is applied for transmission of the uplink resource.

In some embodiments, the request does not comprise an index of RS.

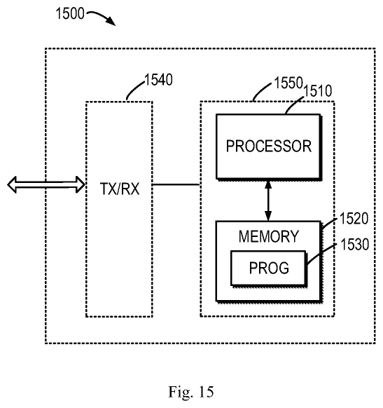

FIG. 15 is a simplified block diagram of a device 1500 that is suitable for implementing embodiments of the present disclosure. The device 1500 can be considered as a further example implementation of the network device 120, or the terminal device as shown in FIG. 1. Accordingly, the device 15100 can be implemented at or as at least a part of the terminal device 110, or the network device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure, as discussed herein with reference to FIGS. 2 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A method performed by a terminal device, the method comprising:
receiving from a network device, an indication of a first transmission configuration indicator (TCI) state in downlink control information (DCI) in a first physical downlink control channel (PDCCH); and
setting a Beam Failure Indication (BFI)_COUNTER to 0 based on a determination that a reference signal (RS) for beam failure detection is changed from a first RS to a second RS.

42. The method of claim 41, further comprising:
determining that the first TCI state is different from a previously indicated TCI state; and
receiving from the network device, a downlink transmission to which the first TCI state is applied starting after a beam application timing.

43. The method of claim 41, further comprising:
determining a first set to include one or more indexes for the second RS with same value as respective RS indexes in RS sets corresponding to the TCI state for respective CORESETs.

44. The method of claim 43, further comprising:
assessing a downlink radio link quality based on the first set in order to detect beam failure.

45. A method performed by a network device, the method comprising:
transmitting to a terminal device, an indication of a first transmission configuration indicator (TCI) state in downlink control information (DCI) in a first physical downlink control channel (PDCCH),
wherein a Beam Failure Indication (BFI)_COUNTER is set to 0 based on a determination that a reference signal (RS) for beam failure detection is changed from a first RS to a second RS; and
performing a downlink transmission to which the first TCI state is applied.

46. The method of claim 45, wherein the first TCI state is different from a previously indicated TCI state, and
wherein the downlink transmission to which the first TCI state is applied starts after a beam application timing.

47. The method of claim 45, wherein a first set is determined to include one or more indexes for the second RS with same value as respective RS indexes in RS sets corresponding to the TCI state for respective CORESETs.

48. The method of claim 47, wherein a downlink radio link quality is assessed based on the first set in order to detect beam failure.

49. A terminal device, comprising:
at least one memory having program instructions stored therein;
at least one processor configured to execute the program instructions that when executed control the terminal device to perform operations comprising:
receiving from a network device, an indication of a first transmission configuration indicator (TCI) state in downlink control information (DCI) in a first physical downlink control channel (PDCCH); and
setting a Beam Failure Indication (BFI)_COUNTER to 0 based on a determination that a reference signal (RS) for beam failure detection is changed from a first RS to a second RS.

50. The terminal device of claim 49, wherein the operations further comprise:
determining that the first TCI state is different from a previously indicated TCI state; and
receiving from the network device, a downlink transmission to which the first TCI state is applied starting after a beam application timing.

51. The terminal device of claim 49, wherein the operations further comprise:
determining a first set to include one or more indexes for the second RS with same value as respective RS indexes in RS sets corresponding to the TCI state for respective CORESETs.

52. The terminal device of claim 51, wherein the operations further comprise:
assessing a downlink radio link quality based on the first set in order to detect beam failure.
